(19) United States
(12) Patent Application Publication
(10) Pub. No.: US 2016/0199738 A1
(43) Pub. Date: Jul. 14, 2016

(54) AUTOMATED STOCK TRANSACTIONS REGARDING COMPONENTS OF SPORTS TEAMS

(71) Applicants: ERIC C. CROMWELL, BRENTWOOD, TN (US); DANIEL R. SCHMISSEUR, BRENTWOOD, TN (US)

(72) Inventors: ERIC C. CROMWELL, BRENTWOOD, TN (US); DANIEL R. SCHMISSEUR, BRENTWOOD, TN (US)

(21) Appl. No.: 14/992,775

(22) Filed: Jan. 11, 2016

Related U.S. Application Data
(60) Provisional application No. 62/101,866, filed on Jan. 9, 2015.

(51) Int. Cl. A63F 13/792; A63F 13/828

(52) U.S. Cl. CPC A63F 13/792; A63F 13/828

(57) ABSTRACT

Implementing automated stock transactions regarding sports teams may be accomplished by a variety of systems, processes, and techniques. In particular implementations, initial stock values associated with components of sports teams may be determined based on rankings for a plurality of sports teams in a plurality of game-based based statistical categories, each statistical category associated with a component of each team, and each team having a separate ranking in each statistical category. Each team may have a separate stock price for each component. These values may be used to initially assign the stocks to contestants. Additionally, revised stock values may be determined based on the initial assignment of stocks to contestants, and an auction function may allow contestants to exchange stocks. A final stock value for each stock may be determined based on the teams' on-field performance in the statistical categories.

### RELATED APPLICATIONS

The present invention claims priority to U.S. Patent Application No. 62/101,866, filed Jan. 9, 2015. This prior application is incorporated herein by reference in its entirety.

### BACKGROUND

The present invention relates to automated stock transactions, and more specifically to automated transactions for stocks associated with components of sports teams.

There are a large number of contests in which contestants manage their own fictional sports teams and compete with other contestants. In these contests, contestants typically assemble their teams by competing in a draft or auction for the right to fictionally manage actual athletes, and the metrics used to measure performance of each team are usually based on the real-world statistics of the individual athletes on each fictional team.

In a football scenario, for example, the statistics could include yards gained, points scored, fumbles, interceptions thrown, completion percentage, yards allowed, takeaways, and points allowed. As another example, in a baseball scenario, the statistics could include hits, homeruns, batting average, stolen bases, earned run average, strikeouts, and saves. These contests typically begin at the beginning of a season and conclude at the end of the season.

### BRIEF SUMMARY

Implementing automated stock transactions regarding components of sports teams may be accomplished by a variety of systems, processes, and techniques. In particular implementations, initial values for stocks associated with components of sports teams may be determined by generating rankings of the teams in a plurality of game-based based statistical categories, each statistical category associated with a component of a team, and each component having a separate ranking in each statistical category. The rankings may then be converted into stock prices associated with each component for each team, each component having a separate stock price for each statistical category. The stocks may then be assigned to contestants by receiving orders from the contestants for stocks on a per team, per component basis and assigning stocks to contestants on a per team, per component basis. Additionally, revised stock values may be determined based on interim poll rankings or an auction function that may allow contestants to exchange stocks for a period of time. A final stock value for the stocks may be determined based on the teams' actual performance metrics in the statistical categories.

### BRIEF DESCRIPTION OF THE SEVERAL VIEWS OF THE DRAWINGS

FIG. 1 is a block diagram illustrating an example system for implementing automated stock transactions regarding components of sports teams.

FIG. 2 is a drawing illustrating an example user interface for presenting values for stocks associated with components of sports teams.

FIG. 3 is a flowchart illustrating an example process for implementing automated stock transactions regarding components of sports teams.

FIGS. 4A-B are a flowchart illustrating an example process for implementing an automated stock exchange regarding components of sports teams.

FIG. 5 is a flowchart illustrating another example process for implementing automated stock transactions regarding components of sports teams.

FIG. 6 is a flowchart illustrating an additional example process for implementing automated stock transactions regarding components sports teams.

FIG. 7 is a flowchart illustrating a further example process for implementing automated stock transactions regarding components of sports teams.

FIG. 8 is a block diagram illustrating an example computer system for implementing automated stock transactions regarding components of sports teams.

### DETAILED DESCRIPTION

Systems, processes, and devices for implementing automated stock transactions regarding components of sports teams may have a variety of implementations. In certain implementations, for example, stocks associated with components of teams may initially be offered to contestants at values based on the associated teams' rankings (e.g., in one or more experts' polls or one or more computer simulations) in various statistical categories. That is, each team may have an associated stock in each statistical category, each of which is associated with a team component. The stocks may then fluctuate in value as they are traded between contestants based on each contestant's perception of the value of the stocks or they may fluctuate based on interim poll rankings. Moreover, a final determination of the value of the stocks may be made at one or more points (e.g., after a game or series of games has been played), and the accounts of the various contestants credited.

As will be appreciated by one skilled in the art, aspects of the present disclosure may be implemented as a system, method, or computer program product. Accordingly, aspects of the present disclosure may take the form of an entirely hardware environment, an entirely software embodiment (including firmware, resident software, micro-code, etc.), or an implementation combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be a tangible medium that can contain or store a program for use by or in connection with an instruction execution system, apparatus, or device.

A computer readable signal medium may include a propagated data signal with computer readable program code embodied therein, for example in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any medium, including but not limited to wireless, wireline, optical fiber cable, RF, etc. or any suitable combination of the foregoing.

Computer program code for carrying out operations for aspects of the disclosure may be written in any combination of one or more programming languages such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described below with reference to flowchart illustrations and/or block diagrams of methods, apparatus (systems), and computer program products according to implementations. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other device to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions that execute on the computer or other programmable apparatus provide processes for implementing the functions/acts specified in the flowchart and/or block diagram block or blocks.

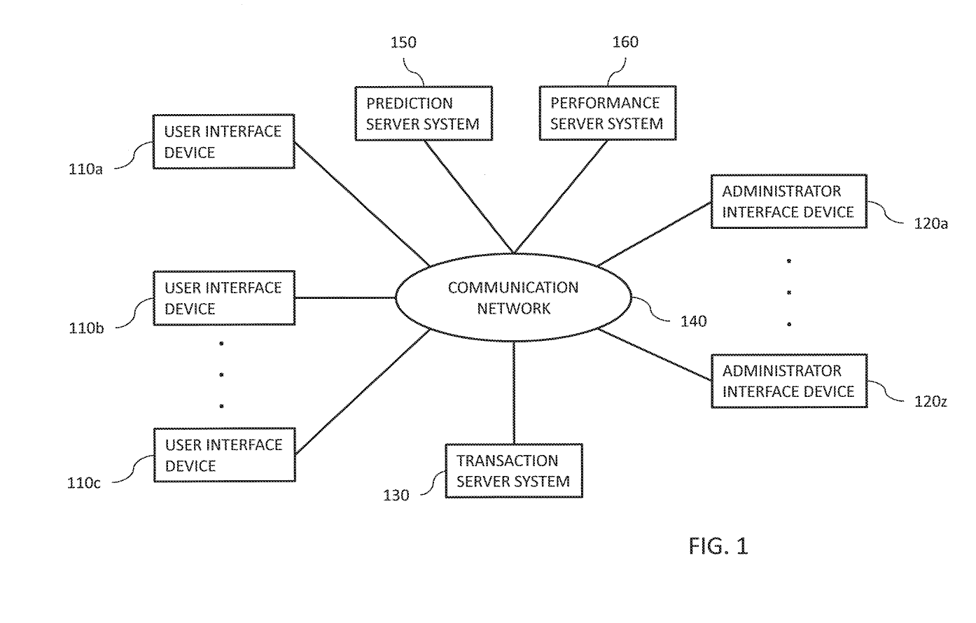

FIG. 1 illustrates an example system 100 for implementing automated stock transactions regarding components of sports teams. In the discussion that follows, system 100 will mainly be described as implementing an automated stock exchange. However, system 100 may also implement other automated stock transactions, which will also be discussed in more detail below.

Among other things, system 100 includes user interface devices 110 for contestants in the automated stock transactions, administrator interface devices 120 for administrators of the automated stock transactions, and a transaction server system 130 that executes the stock transactions. User interface devices 110, administrator interface devices 120, and transaction server system 130 communicate with each other through a communication network 140.

In general, user interface devices 110 may be any type of logical devices that can receive information and present it to a user and receive information from a user and send it. User interface devices 110 may, for example, be personal computers, laptop computers, personal digital assistants, tablets, and/or smart phones. Through user interface devices 110, contestants may review the stocks that are available, buy and sell stocks, and track their portfolios, all of which will be discussed in more detail below.

Administrator interface devices 120 may also generally be any type of logical devices that can receive information and present it to a user and receive information from a user and send it. Administrator interface devices 120 may, for example, be personal computers, laptop computers, personal digital assistants, tablets, and/or smart phones. Through administrator interface devices 120, an administrator of the automated stock exchange may monitor the buying and sell of stocks to make sure the stock transactions are functioning properly and also make a market for stocks as required, all of which will be discussed in more detail below.

Transaction server system 130 is responsible for, among other things, calculating stock values, executing stock transactions, and providing stock, team, and athlete data to contestants. Transaction server system 130 may be composed of one or more servers or clusters of servers (whether co-located or not). In particular implementations, transaction server system 130 may enter into a client-server relationship with user interface devices 110 and administrator interface devices 120.

Communication network 140 may be any network or combination of networks for allowing user interface devices 110, administrator interface devices 120, and transaction server system 130 to communicate with each other. For example, communication network 140 may include a local area network, a wide area network, and/or the Internet.

As illustrated, system 100 also includes a prediction server system 150 and a performance server system 160. Prediction server system 150 is responsible for projecting statistical performance for teams on a game by game basis. Various services offer this analysis, such as Game Simulator, available from The SCACCHoops.com and The Predictalator from PredictionMachine.com of Cincinnati, Ohio (USA). Prediction server system 150 may be composed of one or more servers or clusters of servers (whether co-located or not). Performance server system 160 is responsible for compiling and reporting real-world game statics. Various services offer this analysis, such as STATS LLC of Northbrook, Ill. (USA) and Sport Radar US LLC of Minneapolis, Minn. (USA). Performance server system 160 may be composed of one or more servers or clusters of servers (whether co-located or not). Prediction server system 150 and performance server system 160 provide data to transaction server system 130 through communication network.

In certain modes of operation, the automated stock transactions are begun by establishing initial values for stocks that are associated with the sports teams' components. Components of a sports team may, for example, be its offense and its defense. In certain implementations, however, the components of a sports team may be more granulated. For example, in the football context, the components of a team may be rushing offense, passing offense, scoring offense, total offense, rushing defense, passing defense, scoring defense, and total defense. Note that some of the components may overlap with each other (e.g., rushing offense and total offense), but even if two components are correlated to a degree, they may still be used together. This data may, for example, be calculated by prediction server system 150 and communicated to transaction server system 130, which calculates the share prices based on the data.

As an example of determining the initial values of the stocks, many sports (e.g., college football, college basketball, professional football, professional basketball, etc.) have computerized services that project statistical performance for teams on a game to game basis, and the initial stock values may be based on using the projected statistical performance for the teams in a variety of statistical categories to compile rankings in each of the statistical categories, perhaps with a small discount to initiate acquisitions.

For example, a number of game simulations (e.g., 50, 1,000, 10,000, or more) may be run to find projected values for the teams for the statistical categories. The results of each simulation may count as a “vote” that determines “poll points” for each category. For instance, the points may be assigned as follows for a college football scenario:

1^{st} place team gets 50 points

2^{nd} place team gets 49 points

3^{rd} place team gets 38 points

[symbol]

25^{th} place team gets 26 points

Teams ranked 26-40 get 20-24 points each

Teams ranked 41-65 get 15-19 points each

Teams ranked 66-90 get 10-14 points each

Teams ranked 91-125 get 5-9 points each

Thus, the maximum value for a team component would be 2,500 points (assuming it was ranked first in the associated statistical category for all simulations), and the minimum value would be 250 points. Moreover, various combinations of ranking systems may be used, as discussed in more detail below.

Tables 1A-C illustrate example rankings and values of college football teams on a statistical category basis. As illustrated, the rankings and values are typically based on projected statistical performance for upcoming games. Table 1A shows the projected rushing yards for upcoming games, Table 1B shows the projected passing yards for upcoming games, and Table 1C shows the projected points scored for upcoming games. The projected statistical performance may be an accumulation of projected statistics. For instance, the projections of several services could be combined (e.g., by averaging) to determine a composite ranking and that may be used. The value could be based on combining points from a number of rankings.

TABLE 1A
Rushing Yards

| Rank | Team | Projected Yds | Avg. Yds | Value |
|---|---|---|---|---|
| 1 | Wisconsin | 289 | 251 | 1938 |
| 2 | Alabama | 224 | 238 | 1914 |
| 3 | Oregon | 205 | 198 | 1888 |
| 4 | UCLA | 198 | 201 | 1824 |
| ... | ... | ... | | ... |
| 124 | Washington State | 48 | 68 | 295 |
| 125 | Wake Forest | 41 | 27 | 278 |

TABLE 1B
Passing Yards

| Rank | Team | Projected Yds | Avg. Yds | Value |
|---|---|---|---|---|
| 1 | Washington State | 512 | 554 | 2012 |
| 2 | Baylor | 478 | 443 | 1998 |
| 3 | Oregon | 401 | 398 | 1925 |
| 4 | Florida State | 387 | 370 | 1901 |
| ... | ... | ... | | ... |
| 124 | Vanderbilt | 187 | 150 | 302 |
| 125 | Army | 150 | 167 | 255 |

TABLE 1C
Scoring

| Rank | Team | Projected Points | Avg. Points | Value |
|---|---|---|---|---|
| 1 | Baylor | 48.6 | 44.8 | 1922 |
| 2 | TCU | 42.3 | 39.6 | 1912 |
| 3 | Oregon | 39.1 | 40.2 | 1875 |
| 4 | Ohio State | 38.2 | 25.8 | 1869 |
| ... | ... | ... | | ... |
| 124 | Vanderbilt | 13.2 | 18.5 | 278 |
| 125 | Army | 12.1 | 11.9 | 276 |

As can be seen in Table 1A, Wisconsin is projected to rush for the most yards in the upcoming games, followed by Alabama and Oregon. But note that the projection is not necessarily the average rushing yards. Thus, for example, the quality of the defense that a team is competing against may be taken into account to determine their projected yards in their next game. Once a projection can be made for a number of teams' rushing yards, a ranking of the teams may be determined and the stock prices generated.

In other implementations, the stock prices could be computed in a different manner. For example, they could be linearly scaled based on the ranking (e.g., (126−ranking)*10)). However, other linear scaling or algorithms could be used. For instance, the prices may be assigned on an exponential scale based on the ranking. Moreover, instead of the ranking, the projected statistical value (i.e., yards in this case) could be used. Typically, as long as a monotonically decreasing function is used, the game should operate in a logical manner.

Tables 1 B-C illustrate the same concept for teams, but for different statistical categories. The rankings and valuations based on these statistical categories would be similar to those used for the rushing yards. Other statistical categories for football teams could also be used—for example, total yards gained, rush yards allowed, pass yards allowed, total yards allowed, and points allowed. Thus, a contestant may buy fantasy stocks for one or more components of a team (e.g., rushing offense, passing defense, and scoring defense) as opposed to the team itself. A contestant may also buy components of different teams.

Tables 1A-C are also examples of user interfaces that may be presented to a contestant on a user interface device 110. Additional data may also be included in a user interface. For example, a team's next opponent and their statistical average (e.g., rushing yards) could be presented.

In some implementations, more teams may have associated values than there are ranking positions. For instance, there may be more teams than there are ranking positions. (In college football, for example, polls often rank 25 teams when there are around 125 teams in total.) Thus, values may also be assigned for team components that are outside of the available ranking positions or do not have a projected performance statistic. Values for stocks associated with these components of teams may typically be assigned between zero and the last team with a value. In certain implementations, however, rankings may be used that rank all of the teams, as illustrated in Tables 1A-C. Thus, components of teams that are not traditionally ranked in polls may have values based on rankings.

After determining initial values, with possibly a small discount for initial sales, the teams could then be traded on the exchange based on the contestants' estimates regarding the teams' final rankings. The final values for the stocks could be determined, for example, after the next series of games are played (e.g., on a weekend).

To participate in the automated stock exchange, contestants may pay a fee (e.g., $10-$25) or receive an invitation to participate from an organizer (e.g., of a league, a party, a promotional event, or other appropriate group) or play for free under the specific terms of a sponsored league. The fee to join as an individual or to be a group organizer may, for example, be paid by credit card or PayPal. Each contestant is allotted a certain amount of credits (e.g., “cash” or “points”), which are an artificial tender internal to the exchange. In certain implementations, contestants may also be assigned or allowed to specify security code (e.g., a username and a password).

The number of allotted credits could be based on the valuations of the teams and the number of team components. For example, for the scenarios shown in Tables 1A-C, a player may need around 5000 points to buy an array of teams in a component (e.g., several top ranked rushing offenses, several middle level rushing offenses, and several lower ranked rushing offenses). Thus, the player may need around 15,000 points to buy an array of teams in each of the three statistical categories. These numbers could be used to allot credits to each contestant so that they could buy the stocks associated with various combinations of team components. In other implementations, different amounts of credits could be awarded.

In particular implementations, not all contestants may be allotted the same amount of credits. For example, a contestant paying a smaller fee may be allotted a smaller amount of credits, and a contestant paying a larger fee may be allotted a larger amount of credits.

In certain implementations, a contestant may only be allowed to buy one share of stock associated with a team, which should encourage a contestant to develop a portfolio of investments. Moreover, a contestant's portfolio of stocks may be limited to a maximum number of stocks (e.g., 10-25). In other implementations, a contestant may be allowed to buy multiple shares of stock associated with a team and/or fractional shares of stock.

As with most stock transactions, the goal of the contestant is to maximize returns on a portfolio of stocks, which in this case represent pseudo-financial returns imputed from the potential value of teams' statistical performance as opposed to companies' financial performance. As is typical, one way for a contestant to increase the value of a stock is to purchase one that may be undervalued by the market at a point in time and sell when it increases in value at a future time, which may be hours, days, or weeks later. A stock typically increases in value by the associated team performing well in a statistical category during a game and, hence, acquiring a higher ranking in a statistical category. The stock, of course, can also fall by the team not performing well, as well as a host of other issues (e.g., injuries, bad weather, better teams emerging, etc.).

Upon registering, contestants may be provided with biography information on available teams so that they can make their initial acquisitions. This information may be sortable based on various parameters (e.g., market value, volume, and conference).

As initial sales progress, the contestants begin to develop their portfolio of stocks. Moreover, these sales may be used to set the values for the stocks in the future (e.g., depending on the demand for the stock at the initial value). Later, users may buy/sell stocks according to current market values. Thus, secondary markets may develop, which are based on the contestants perception of the potential of a team.

Contestants may follow any strategy that they would like. For example, some contestants may use a diversified strategy in which they focus on a broad range of team components, while others may focus on a specific category such as rushing yards. The stock values associated with these may fluctuate widely in the hours before a big game. As another example, some contestants may be affinity contestants, in which they aggregate stocks associated with teams from their region (e.g., state) and/or favorite conferences. As a further example, some contestants may look for stocks with the potential for unusual outcomes in which they aggregate a portfolio of stocks associated components of teams not expected to perform well in a particular category. In the football scenario discussed above, for example, a team component valued at 500 points initially could easily turn into a 2,500 point value if it made it to the top of the rankings, which is a 400% return on investment. Moreover, contestants could short the stocks of one or more team components, which means that the contestants project the stocks' value will decrease. It is possible for a contestant to lose all of his credits (e.g., if the value of all his stocks drops to zero or if he has all short picks, and they increase in value). In certain implementations, however, contestants may be allowed to purchase more credits.

In certain modes of operation, system 100 may operate as an automated stock exchange. In some of these modes, after the initial purchasing of the stocks, the value of the stocks may be reassessed automatically (e.g., based on demand), and the contestants may generally buy and/or sell stocks at any point in time while the automated stock exchange is active, although the execution of the orders may take a while depending on trading volume for a stock. Contestants may be allotted a number of transactions (e.g., 15-25) with their initial credit allotment and then be charged money (e.g., $0.10-$1.00 per transaction) and/or credits (e.g., a fixed amount (e.g., 150 credits) or a transaction percentage) for larger numbers of transactions.

Contestants may be provided with biography information on available teams so that they can make their selections. This information may be sortable based on various parameters (e.g., market value, volume, position, conference, team, and home state). Moreover, this information may be updated as new information becomes available.

Contestants may generally be allowed to buy and sell stocks at the current market value established by the system, or in other implementations, by placing orders to buy the stock at a bid value or sell the stock at an ask value. In certain implementations, contestants may place market orders and limit orders to buy and sell stocks. An automated auction system may match buyers to sellers. In certain implementations, administrators may be given final approval of some or all of the exchanges. This may assist with investigating suspicious activities (e.g., large bid/ask spreads).

In some modes of operation, system 100 may determine stock values based on updates in projections by rating services. The updated projections may be correlated to rankings. The values of the stocks may be determined based on one or more experts' and/or rating services' projections. For instance, the projections of several ratings services could be combined to determine a composite rating and that may be used and/or mapped to the stock value. The updates may be performed on a time basis (e.g., hourly, daily, or weekly) and/or an event basis (e.g., after injury updates, etc.).

In some implementations, the contestants may not actually exchange stock with each other. For example, there may be shares available for each of the contestants.

Additional contestants can generally be allowed to participate in the automated stock exchange at any time. These contestants would also typically pay a fee for credits, and they would then be allowed to purchase team stocks at current market values.

The automated stock transactions can generally be started at any time and can last for almost any period of time (e.g., hours, days, or weeks). For example, some projections could come out days before a set of games, and the contest started then. As another example, projections could come out shortly before a game (e.g., less than a day), and the contest could be started then.

In determining the final values of the stocks for some implementations, the actual statistical performance of the teams could be analyzed. This may, for example, be obtained by transaction server system 130 from performance server system 160. For college football, for instance, the rushing yards for each team for the games during a week could be collected and analyzed. Table 2 illustrates the results of an analysis performed for the projected date in Table 1A.

TABLE 2
Rushing Yards Final Values

| Proj | Actual | | Proj | Actual | Proj | Actual | Value |
|---|---|---|---|---|---|---|---|
| Rank | Rank | Team | Yds | Yds | Value | Value | Change |
| 1 | 3 | Wisconsin | 289 | 237 | 1938 | 2400 | 462 |
| 2 | 1 | Alabama | 224 | 254 | 1914 | 2500 | 586 |
| 3 | 2 | Oregon | 205 | 239 | 1888 | 2450 | 562 |
| 4 | 16 | UCLA | 198 | 145 | 1824 | 1750 | −74 |
| . . . | | . . . | . . . | | . . . | | |
| 124 | 125 | Washington | 48 | 25 | 295 | 250 | −45 |
| | | State | | | | | |
| 125 | 108 | Wake | 41 | 88 | 278 | 350 | 72 |
| | | Forest | | | | | |

The final values are based on a team achieving a position in a ranking. Thus, if a team is ranked first based on actual on-field performance (e.g., rushing yards), it receives all of the points/value for the first place team. As illustrated, teams that did worse than expected lost value, and teams that did better than expected gained value. A similar analysis could be conducted for other statistical categories (e.g., those in Tables 1B-C).

As particular examples, suppose a team was ranked around 99^{th} in relative value for a team component (e.g. rush yards) for an upcoming round of games. At around the 99^{th} rank, a team component would have a value of around 500 points in the illustrated examples. However, if that team actually placed 6^{th} overall for the week for that team component, the value of the stock associated with the team component would rise to 2,250 points.

As another example, assume that a team was ranked right near the top in terms of a team component for an upcoming round of games. The team component value could, for example, be around 2,100 points. Placing 1^{st} overall would score 2,500 points, for a gain of 400 points in value. Placing 20^{th} overall would score 1,550 points, for a loss of 1,550 in value.

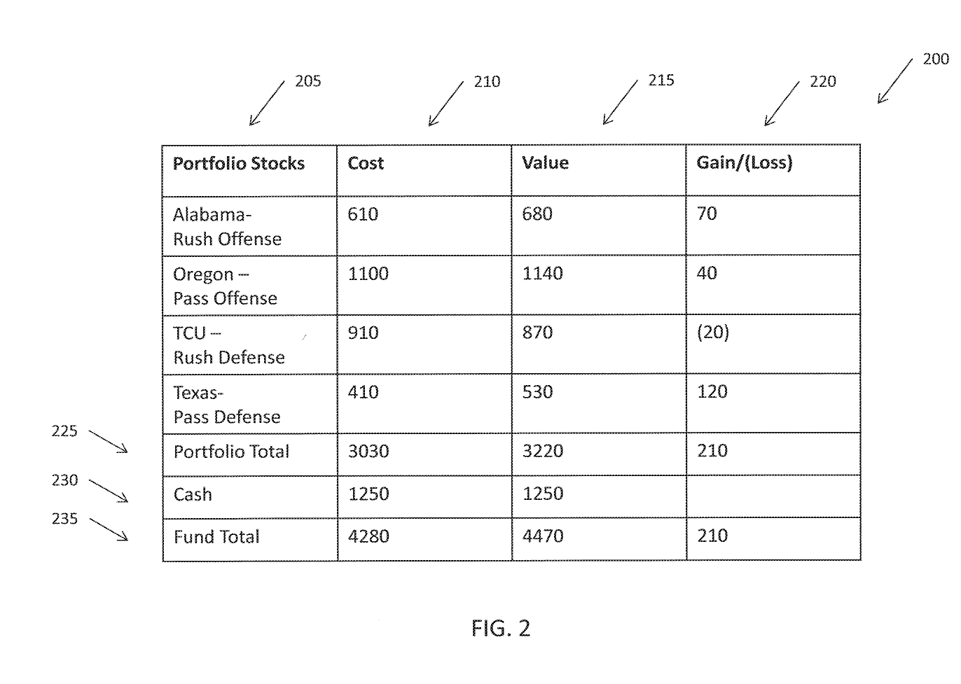

FIG. 2 illustrates an example user interface 200 that may be presented to a user (e.g., contestant) on the user's interface device in a college football scenario. User interface 200 may, for example, be presented in a web browser or other graphical user interface.

As illustrated, user interface 200 lists the stocks that a contestant has in his portfolio in a section 205. The cost of each stock is listed in a section 210, the value of each stock is listed in a section 215, and the gain (or loss) for each stock is listed in a section 220. Thus, a contestant can readily see which stocks have gained in value and which have lost in value. User interface 210 may be presented while games are being played (in which case it may not be complete regarding values) or after the games are complete.

Additionally, the total values for the contestant's stock portfolio are shown in a section 225. Thus, the contestant may readily observe the aggregate loss/gain for his portfolio. Furthermore, the contestant's available “cash”—an artificial currency internal to the system—is shown in a section 230, and the total value of the contestant's fund is shown in a section 235.

Although FIG. 2 illustrates one user interface 200 for a user, a variety of other user interfaces are possible. For example, a user interface may not present the gain. As another example, a user interface may present more detailed stock data regarding the stocks in a portfolio. For instance, a user interface may present current bid values, current ask values, stock volumes traded over a time period (e.g., in a week), historical highs, historical lows, and the current value of the stocks, which may be based on one or more poll rankings or the last market trade. Thus, the contestant can readily see if the current values look like a good value or not. User interface 200 may also present the contestant's previous stock holdings in a section.

A user interface may also present experts'/services' analysis regarding performance. As an additional example, a user interface may contain a number of stocks that the contestant is watching, along with any of their current stock exchange information. As a further example, a user interface may present outstanding orders of the contestant.

In particular implementations, the user interface may be customizable by the user to present information that the user desires. Moreover, information from the user interface may be extracted and customized into a stock ticker for the contestant (e.g., recent market trade for stocks owned or being watched). A ticker may also be added for breaking news about teams and/or athletes.

In certain implementations, a user may be presented with a dashboard when the user logs in to transaction server system 130. The dashboard may contain the user's personal information (e.g., account status, portfolio value, place in standings, news on teams in portfolio, and news on teams on a watch list). The dashboard may also contain information on the market (e.g., top 25 most active stocks, biggest gainers, unusual trading or bidding activities, etc.). Additionally, the dashboard may contain general team information (e.g., news ticker for information that impacts stock values, expert projections, etc.).

Transaction server system 130 is responsible for operating the automated stock transactions. In particular, transaction server system 130 can track the accounts for the contestants and provide the account information to the contestants. Additionally, when contestants place buy and/or sell orders in exchange implementations, the server system can perform an auction function to exchange the stocks. For example, if a contestant places a buy order, the server system may rank the sell orders based on value and determine if there is an agreement between the value for the buy order and the value for the lowest sell order. Thus, the buyer should obtain the stock at the lowest available value.

Transaction server system 130 may operate a stock exchange as a call market and/or a continuous market. If operated as a call market, the exchanges could, for example, be settled twice daily. If operated primarily as a continuous market, transaction server system 130 may also operate a call market for determining opening values if orders build up when trading is closed or suspended.

In particular implementations, transaction server system 130 may also implement automatic market controls (e.g., to avoid bubbles). For example, in a football scenario, the server system may ensure that the cumulative market value does not exceed the total point value from the rankings or that a team is not double-counted by a pollster. Transaction server system 130 may also have financial barometers to adjust market values to maintain approximate distribution relative to points values.

Transaction server system 130 may also provide information to contestants. For example, when the server system has information regarding a team or athletes, the system may determine the contestants that own one or more stocks associated with the team and/or that are watching the stock and send a message (e.g., e-mail, text, etc.) to the contestants. Moreover, the server system may publish the information (e.g., post it to a web-site). Additionally, the server system may publish a contestant leaderboard, which may be sortable by various parameters (e.g., portfolio size, region, state, city, IRR, capital gains, etc.).

Transaction server system 130 may also determine the final values to be assigned to the stocks (e.g., when a series of games is over) and determine the gains/losses for each of the contestants. Contestants that have managed their portfolio the best (i.e., biggest gains, biggest percentage gains, etc.) and worst (i.e., biggest losses) may be identified. These may also be broken out by class (e.g., 10,000 credit class, 25,000 credit class, and 50,000 credit class). Transaction server system 130 may also provide awards (e.g., free entry fee for next round) to those contestants that have performed the best.

Transaction server system 130 may also operate a private league between certain contestants. In such leagues, contestants typically compete against themselves for intra-league recognition. Private leagues may be set up based on a flat fee for the league and/or a cost for the number of contestants. Additionally, transaction costs may or may not be applied. The values for the league may be determined based on the trading in the open exchange. Transaction server system 130 may also provide an accounting system for the league, but would typically not be set up to handle cash exchanges, if any, between league members. Transaction server system 130 may also rank leagues against each other (e.g., for portfolio value creation) and provide awards to leagues that perform the best.

Transaction server system 130 may provide league management tools for private leagues. For example, the league organizer (e.g., commissioner) may be provided with options to set up the league, invite players, and create a message board. Additionally, league standings may be published for league contestants and sorted by various metrics (e.g., capital gains).

As mentioned above, system 100 also includes administrator interface devices 130, which provide access to administrators of the automated stock exchange. The administrators may, for example, be responsible for addressing bubbles in the market and making a market for stocks that are not heavily traded. For example, an administrator may be provided with a certain number of shares of stock for each team. Thus, if there are no sellers when a buy order comes in, the administrator may sell its stock to the buyer. Additionally, if they are no buyers when a sell order comes in, the administrator may buy the stock. As more contestants are added to the automated stock exchange, more stock may be allotted to the administrators. Additionally, if a contestant desires to add a new stock to the market, which would be associated with a new team, the contestant may contact an administrator who will make a determination as to whether there is sufficient interest to add stock for the team.

System 100 provides a variety of features. For example, system 100 provides users a stock transaction contest in which the contestants buy, sell, trade, and own stock associated with components of sports teams. Additionally, system 100 allows the contestants to judge how well they are performing against other contestants and provides a final ranking of the contestant. Moreover, a contest may be concluded after a round of games (e.g., on a weekly basis) and restarted at almost any time (e.g., for the next week).

As an example of the potential complexity of system 100, in a college football scenario, there may be 1,000 stocks (or more) for which to determine the value (e.g., 125 teams with 8 different components). If 50 simulations of each game are used to determine the stock values, there will be over 6,000 data sets to be used in determining the value for each team component, and close to 50,000 overall. (Moreover, the valuations may have to be restarted after each round of games (e.g., each week).) Additionally, there may be tens of thousands, if not millions, of contestants using system 100 to buy and sell stocks. Thus, there will most likely be millions, if not billions, of calculations that system 100 may have to perform on a daily basis.

Although system 100 has been primarily discussed with respect to college football, it should work equally well with other sports. For example, professional football has statistics quite similar to college football. Additionally, basketball (e.g., college and professional) has their own statistics that can be used (e.g., points scored, points scored against, offensive rebounds, defensive rebounds, assists, blocks, turnovers, steals, shooting percentage, etc.). As another example, baseball has a variety of statistics (e.g., runs scored, hits, home runs, earned run average, slugging percentage, etc.) that could be used in system 100. Other sports (e.g., soccer and hockey) may also be used in system 100 in which statistical categories may be used to identify components of sports teams.

Although FIG. 1 illustrates an example system for implementing automated stock transactions regarding components of sports teams, other systems for implementing automated stock transaction regarding sports teams may include fewer, additional, and/or a different arrangement of elements. For example, the prediction server system may be part of the transaction server system. Additionally, the performance server system may be part of the transaction server system. Some embodiments may not include a performance server system. For example, the performance data could be entered directly to the transaction server system.

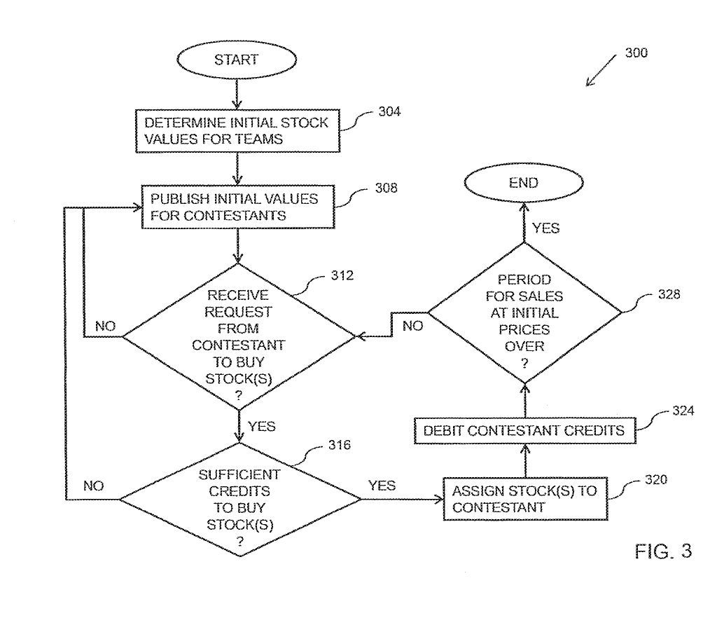

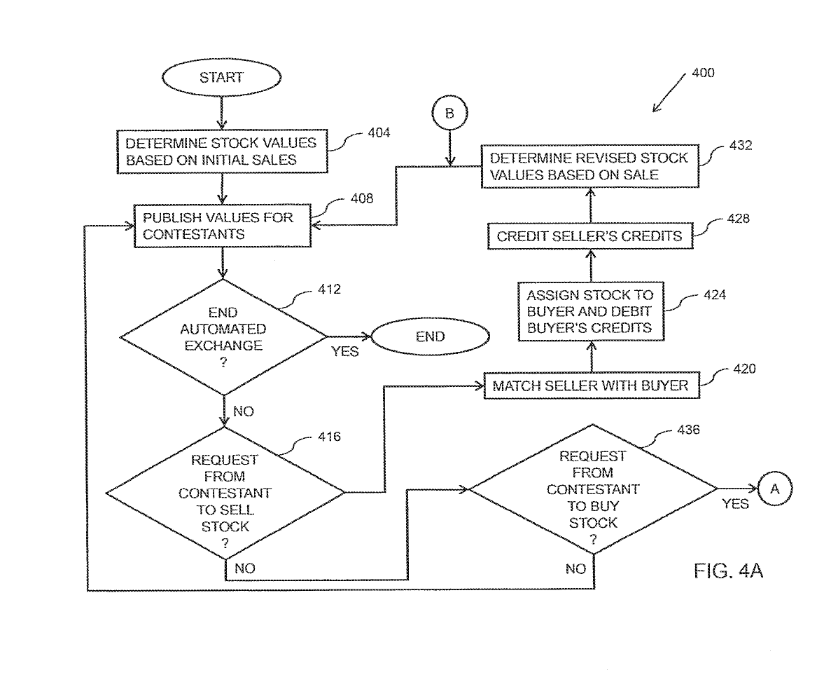

FIG. 3 illustrates a process 300 for providing automated stock transactions regarding components of sports teams. Process 300 may, for example, be implemented by system 100.

Process 300 begins with determining an initial value for stocks associated with components of sports teams (operation 304). For example, the value of a group of stocks could be based on ranking of the teams' projected performance in a statistical category, which could be mapped to a team component. The projected performance could, for example, be from a prediction server system. This could be repeated for multiple statistical categories. Note that not all teams may have a value based on rankings (e.g., for teams that have no ranking). The values for stocks associated with these teams may be determined using the lower ranked teams in the rankings. Process 600 also calls for publishing the initial stock values for the teams' components for a game's contestants (operation 308). The publication could be performed through direct communication (e.g., e-mail) or through centralized postings (e.g., on a web site).

Process 300 further calls for determining whether a request has been received from a contestant to buy one or more stocks (operation 312). Once a request from a contestant has been received, process 300 calls for determining whether the contestant has sufficient credits to buy the stock(s) (operation 316). Each contestant may, for example, have been allotted credits when registering for the game. If the contestant has sufficient credits, process 300 calls for assigning the requested stock(s) to the contestant (operation 320) and debiting the contestant's credits (operation 324).

Process 300 also calls for determining whether the period for initial sales is over (operation 328). The period may, for example, be set for a specific time (e.g., a few hours, a few days, or a week) or event (e.g., until a number or percentage of stocks has been purchased). If the period for sales at the initial values is not over, process 300 calls for determining whether an additional request to buy stock(s) has been received (operation 312). If the period is over, process 300 is complete.

Although FIG. 3 illustrates one process for providing automated stock transactions regarding components of sports teams, other similar processes may contain fewer, additional, and/or a different arrangement of operations. For example, a process may include registering contestants and/or allotting credits. Additionally, a process may allow one or more contestants to form a league. As another example, a process may not determine if a period for initial sales is over.

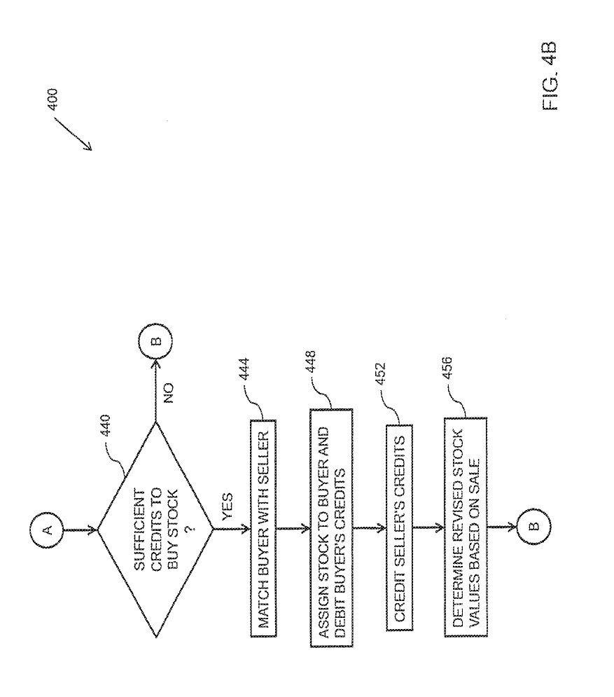

FIGS. 4A-B illustrate a process 400 for providing an automated stock exchange regarding components of sports teams. In certain implementations, process 400 may be implemented in conjunction with process 300. Process 400 may, for example, be implemented in a system like system 100.

Process 400 begins with determining stock values for components of sports teams based on initial sales to contestants (operation 404). The initial sales may, for example, have occurred during an initial offering of the stocks to contestants. For instance, contestants could submit buy orders for a period of time, such as one week prior to the opening of the exchange, and a computer algorithm could be used to determine the actual prices at which the initial trades would be executed, based on demand and relative prices from the buy orders.

Process 400 also calls for publishing the stock values for contestants (operation 408) and determining whether to terminate the automated stock exchange (operation 412). The automated stock exchange may, for example, terminate at a specific event (e.g., after a series of games) or at a specific time (e.g., the end of the regular season). If the automated stock exchange should be terminated, process 400 is at an end.

If the automated stock exchange should not be terminated, process 400 continues with determining whether a request has been received from a contestant to sell a stock (operation 416). If a request to sell a stock has been received, process 400 calls for matching the buyer with a seller (operation 420). Process 400 may, for example, accomplish this by performing an auction function.

If the buyer is matched to a seller, process 400 calls for assigning the stock to the buyer and debiting the buyer's credits (operation 424) and crediting the sellers credits (operation 428). Additionally, process 400 calls for determining revised stock values based on the sale (operation 432), assuming it was the last executed transaction.

If there is no request to sell a stock, process 400 calls for determining whether a request has been received from a contestant to buy a stock (operation 436). If there is no request from a contestant to buy a stock, process 400 calls for continuing to publish the stock values (operation 408).

If a request to buy a stock has been received, process 400 calls for determining whether the contestant has sufficient credits to buy the stock (operation 440). If the buyer does not have sufficient credits, process 400 calls for continuing to publish the stock values (operation 408). If, however, the contestant has sufficient credits, process 400 calls for matching the buyer with a seller (operation 444). Process 400 may, for example, accomplish this by performing an auction function.

If the buyer is matched to a seller, process 400 calls for assigning the stock to the buyer and debiting the buyer's credits (operation 448) and crediting the seller's credits (operation 452). Additionally, process 400 calls for determining revised stock values based on the sale (operation 456), assuming it was the last executed transaction. The process continues with publishing stock values (operation 408).

Although FIGS. 4A-B illustrate one example process for implementing automated stock transactions regarding sports teams, other processes for implementing automated stock transactions regarding sports teams may include fewer, additional, and/or a different arrangement of operations. For example, some processes may include limit orders, in which a contestant specifies a price at which they are willing to do something (e.g., buy or sell). If there is no corresponding contestant order (e.g., buy or sell) that matches the limit order, the limit order may be held until a corresponding order occurs. As another example, a process may include revising contestant accounts based on the revised stock values. Moreover, many of the operations in process 400 may be performed simultaneously and/or contemporaneously. For example, orders for buying and selling stocks may be received and executed at substantially the same time. Additionally, processes may be provided for selling stock short.

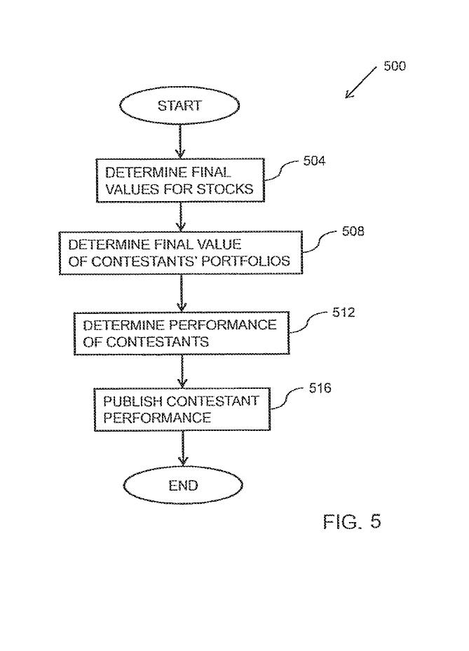

FIG. 5 illustrates another example process 500 for providing automated stock transactions regarding components of sports teams. In certain implementations, process 500 may be implemented in conjunction with process 400. Process 500 may, for example, be implemented in a system like system 100.

Process 500 begins with determining a final value for stocks (operation 504). The final value for stocks may, for example, be based on rankings of the associated teams' components based on actual on-field performance in various statistical categories. The rankings may be based on actual performance data, which could, for example, be from a performance server system. Using the final stock values, process 500 continues with determining the final value of the contestants' portfolios (operation 508).

Process 500 also calls for determining the performance of the contestants (operation 512). For example, the contestants can be evaluated based on largest gains and/or largest percentage gains. Moreover, these may be broken down by capitalization class. Process 500 additionally calls for publishing the contestant performance (operation 516). Thus, contestants can see how they fared relative to other contestants. Process 500 is then at an end.

Process 500 may be performed multiple times during a season. For example, in college football, process 500 could be executed after the games every week.

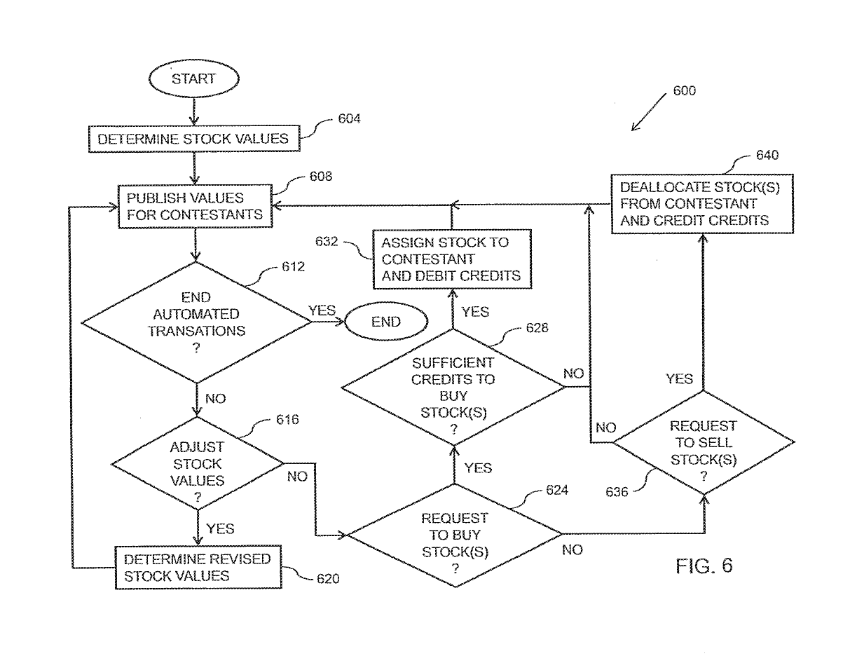

FIG. 6 illustrates an additional example process 600 for implementing automated stock transactions regarding components of sports teams. In certain implementations, process 600 may be implemented in conjunction with process 500. Process 600 may, for example, be implemented in a system like system 100.

Process 600 begins with determining stock values for components of sports teams (operation 604). The stock values may, for example, be based on rankings in one or more statistical categories.

Process 600 also calls for publishing the values for contestants (operation 608) and determining whether to terminate the automated stock transactions (operation 612). The automated transactions may, for example, terminate at a specific event (e.g., after a round of games) or at a specific time (e.g., at the beginning of a set of games). If the automated transactions should be terminated, process 600 is at an end.

If, however, the automated transactions should not be terminated, process 600 continues with determining whether to adjust stock values (operation 616). Adjusting the stock values may, for example, occur on a periodic bases (e.g., daily) or an event basis (e.g., after new information—injury reports, for example—is available). If the stock values should be adjusted, process 600 calls for determining revised stock values (operation 620) and publishing the stock values again (operation 608).

The revised stock values may, for example, be based on updates in rating services. The values of the stocks may be determined based on one or more rating services. For instance, the projections of several ratings services could be combined to determine a composite ranking and that may be used and/or mapped to the stock value.

If stock values should not be adjusted, process 600 calls for determining whether a request has been received from a contestant to buy one or more stocks (operation 624). If a request to buy one or more stocks has been received, process 600 calls for determining whether the contestant has sufficient credits to buy the stock(s) (operation 628). If the contestant has sufficient credits, process 600 calls for assigning the stock to the buyer and debiting the buyer's credits (operation 632). Process 600 then calls for continuing to publish values for the contestants (operation 608). If the contestant does not have sufficient credits, process 600 again calls for continuing to publish values for the contestants (operation 608).

If there is not a request to buy a stock, process 600 calls for determining whether a request has been received from a contestant to sell one or more stocks (operation 636). If there is no request from a contestant to sell a stock, process 600 calls for continuing to publish the stock values (operation 608).

If, however, a request to sell one or more stocks has been received, process 600 calls for deallocating the stock(s) from the contestants and crediting the contestant's credits (operation 640). Process 600 then calls for continuing to publish values for the contestants (operation 608).

Other processes for operating automated stock transactions regarding sports teams may operate similarly to process 600. For example, certain operations (e.g., the buying and selling of stock) may occur simultaneously and/or contemporaneously. Additionally, operations may be provided for selling stock short.

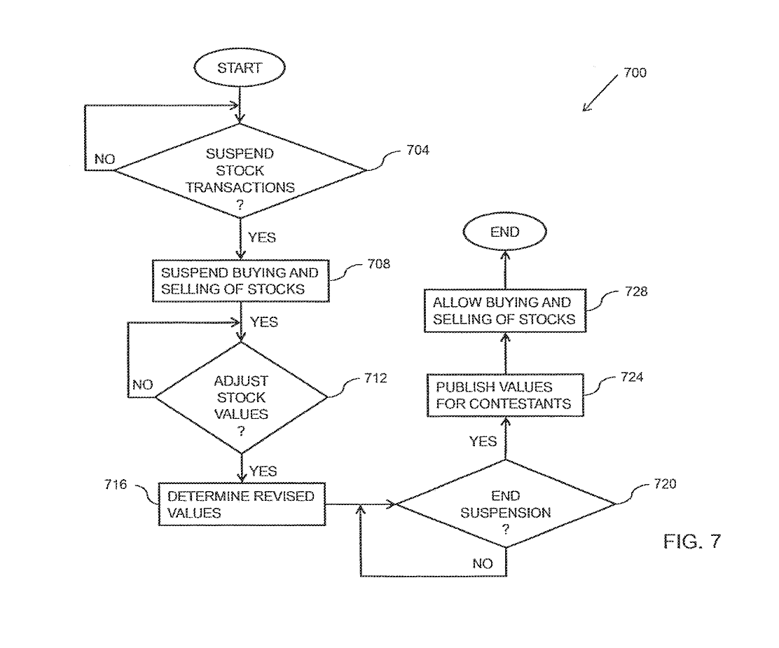

FIG. 7 illustrates an additional example process 700 for implementing automated stock transactions regarding components of sports teams. In certain implementations, process 700 may be implemented in conjunction with process 400 or process 600. Process 700 may, for example, be implemented in a system like system 100.

Process 700 calls for determining whether to suspend stock transactions (operation 704). Stock transactions may, for example, be suspended based on time or an event. For instance, stock transactions may be suspended before a round of games begins for teams. Thus, contestants may not be able to adjust their stock positions during a round of games, or even during a game. As another example, stock transactions may be suspended when the values of the stocks are about to be adjusted. If stock transactions should not be suspended, process 700 calls for continuing to check whether stock transactions should be suspended.

If stock transactions should be suspended, process 700 calls for suspending the buying and selling of stocks (operation 708). Suspending the buying and selling of stocks may, for example, occur by refusing to take any more orders regarding stocks.

Process 700 also calls for determining whether to adjust the stock values (operation 712). The stock values may, for example, be adjusted on a time basis (e.g., weekly) or an event basis (e.g., after a round of games is complete or once a revised ranking poll is established). If the stock values should not be adjusted, process 700 calls for continuing to check whether stock values should be adjusted.

Once the stock values should be adjusted, process 700 calls for determining revised stock values (operation 716). Determining the revised stock values may, for example, occur on a periodic bases (e.g., daily) or an event basis (e.g., after the completion of a round of games). The revised stock values may, for example, be based on rankings of projected or actual on-field performance in various statistical categories.

Process 700 also calls for determining whether to end the stock transaction suspension (operation 720). The suspension may, for example, be ended based on time or an event. For instance, the suspension may be ended after a round of games ends for the teams or when a new ranking poll is issued. If the suspension should not be ended, process 700 calls for continuing to check whether the suspension should be ended.

Once the suspension should be ended, process 700 calls for publishing the revised stock values to the contestants (operation 724). Process 700 also calls for allowing the contestants to buy and sell stocks (operation 728). Process 700 is then at an end.

Although FIG. 7 illustrates one example process for implementing automated stock transactions regarding components of sports teams, other processes for implementing automated stock transactions regarding sports teams may include fewer, additional, and/or a different arrangement of operations. For example, a process may not include adjusting stock values. This may, for example, occur if the stock transactions are being operated as an automated exchange. As an additional example, a process may include revising contestant accounts based on the revised stock values.

The flowcharts and block diagrams in the figures illustrate the architecture, functionality, and operation of systems, methods, and computer program products of various implementations of the disclosure. In this regard, each block in the flowchart or block diagrams may represent a module, segment, or portion of code, which can include one or more executable instructions for implementing the specified logical function(s). It should also be noted that, in some alterative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or the flowchart illustration, and combination of blocks in the block diagrams and/or flowchart illustration, can be implemented by special purpose hardware-based systems the perform the specified function or acts, or combinations of special purpose hardware and computer instructions.

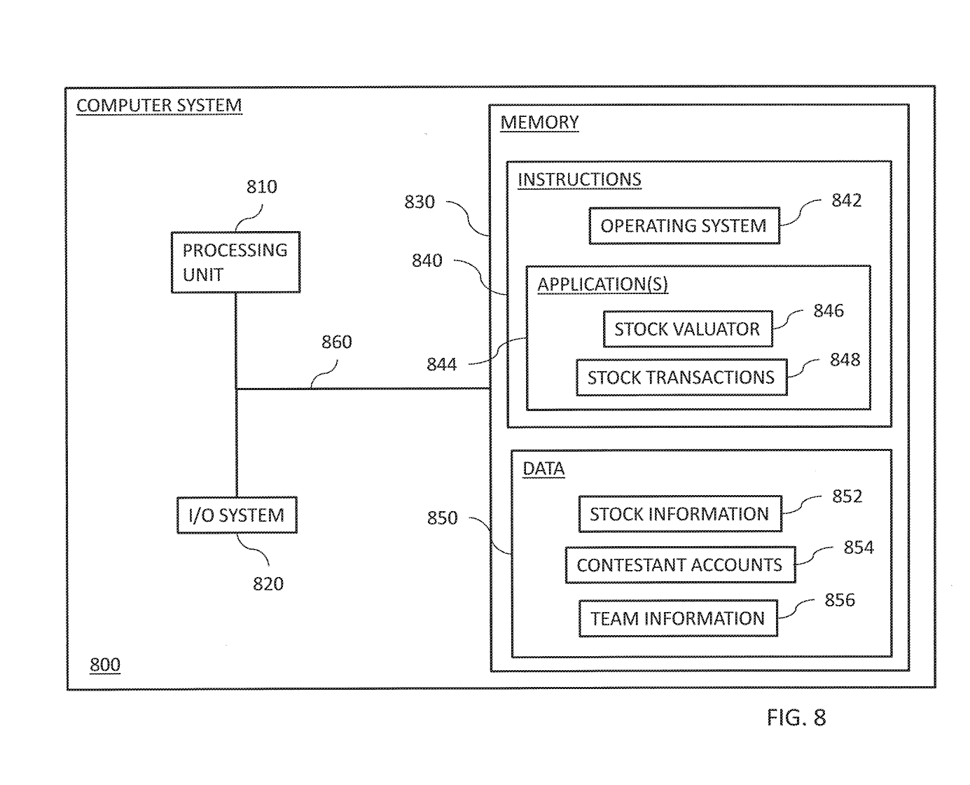

FIG. 8 illustrates an example computer system 800 that can implement automated stock transactions regarding components of sports teams. System 800 includes a processing unit 810, an input/output system 820, and memory 830, which are coupled together by a network system 860.

Processing unit 810 may, for example, include one or more processors (e.g., microprocessors). A processor could, for instance, operate according to reduced instruction set computer (RISC) or complex instruction set computer (CISC) principles. In general, processing unit 810 may be any device that manipulates information in a logical manner.

Input/output system 820 may, for example, include one or more communication interfaces and/or one or more user interfaces. A communication interface may, for instance, be a network interface card (whether wireless or wireless) or a modem. A user interface could, for instance, include one or more user input devices (e.g., a keyboard, a keypad, a touchpad, a mouse, a stylus, or a microphone) and/or one or more user output devices (e.g., a monitor, a display, or a speaker). In general, system 820 may include any combination of devices by which a computer system can receive and output information.

Memory 830 may, for example, include random access memory (RAM), read-only memory (ROM), and/or disc memory. Various items may be stored in different portions of the memory at various times. Memory 830, in general, may be any combination of devices for storing information.

Memory 830 includes instructions 840 and data 850. Instructions 840 include an operating system 842 (e.g., Windows, Linux, or Unix) and applications 844, one of which is a stock valuator application 846, which is responsible for determining stock values, and one of which is a stock transaction application 848, which is responsible for coordinating the buying and selling of stocks. Data 850 includes the data required for and generated by applications 844. For instance, data 850 may hold stock information 852 (e.g., values, volumes, etc.), contestant accounts 854 (e.g., credits, stocks owned, stocks being watched, etc.), and team information 856 (e.g., statistics, injury updates, etc.).

Network system 860 is responsible for communicating information between processing unit 810, input/output system 820, and memory 830. Network system 860 may, for example, include a number of different types of busses (e.g., serial and parallel).

In certain modes of operation, processing unit 810, according to application 846, may determine stock values for sports teams based on one or more projected statistical ratings. For example, the statistical ratings may be used to form rankings for the teams, and the rankings may be used to determine the values. Additionally, processing unit 810 may, according to application 848, establish contestant accounts and disburse stock to contestants based on the stock values. The processing unit may, according to application 846, also determine revised stock values based on actual on-field performance and update the stock values and the contestant accounts. At a terminal point, the processing unit may, according to application 848, determine final stock values and the performance of the contestants. Processing unit 810 may perform these operations according to one or more of the processes described previously.

The terminology used herein is for the purpose of describing particular implementations only and is not intended to be limiting. As used herein, the singular form “a”, “an”, and “the” are intended to include the plural forms as well, unless the context clearly indicates otherwise. It will be further understood that the terms “comprises” and/or “comprising,” when used in the this specification, specify the presence of stated features, integers, steps, operations, elements, and/or components, but do not preclude the presence or addition of one or more other features, integers, steps, operations, elements, components, and/or groups therefore.

The corresponding structure, materials, acts, and equivalents of all means or steps plus function elements in the claims below are intended to include any structure, material, or act for performing the function in combination with other claimed elements as specifically claimed. The description of the present implementations has been presented for purposes of illustration and description, but is not intended to be exhaustive or limited to the implementations in the form disclosed. Many modification and variations will be apparent to those of ordinary skill in the art without departing from the scope and spirit of the disclosure. The implementations were chosen and described in order to explain the principles of the disclosure and the practical application and to enable others or ordinary skill in the art to understand the disclosure for various implementations with various modifications as are suited to the particular use contemplated.

A number of implementations have been described for implementing automated fantasy stock transactions regarding components of sports teams, and several others have been mentioned or suggested. Moreover, those skilled in the art will readily recognize that a variety of additions, deletions, modifications, and substitutions may be made to these implementations while still achieving automated fantasy stock transactions regarding components of sports teams. Thus, the scope of the protected subject matter should be judged based on the following claims, which may capture one or more concepts of one or more implementations.

1. A system for operating automated fantasy stock transactions regarding components of sports teams, the system comprising:
a transaction server system, the transaction server system adapted to:
receive projected performance data for a plurality of sports teams in a plurality of gamed-based statistical categories, each statistical category associated with a component of each team;
determine rankings for the sports teams in the game-based based statistical categories, each team having a separate ranking in each statistical category;
determine stock prices for the components of the teams based on the rankings, each team having a separate stock price for each component;
publish the stock prices to contestants;
receive orders from contestants for stocks on a per team per component basis; and
assign stocks to contestants on a per team per component basis.

2. The system of claim 1, wherein the projected performance data comprises multiple projections for each team in each statistical category.

3. The system of claim 1, further comprising a prediction server system, the prediction server system adapted to determine the performance data for each team in each statistical category and provide the data to the transaction server system.

4. The system of claim 1, wherein the transaction server is further adapted to allot the contestants a number of credits that they can use to acquire stock.

5. The system of claim 1, wherein the transaction server is further adapted to:
determine revised stock values based on the initial assignment of stock to contestants;
publish information regarding the revised stock values; and
facilitate the selling and buying of stock between the contestants based on the revised stock values.

6. The system of claim 1, wherein the transaction server is further adapted to determine a final stock value for each stock based on the teams' game-based performance in the statistical categories.

7. The system of claim 6, further comprising a performance server system, the performance server system adapted to provide game-based statistics to the transaction server system.

8. The system of claim 6, wherein the transaction server is further adapted to determine contestant performance based on the final stock values.
